(19) United States
(12) Patent Application Publication
(10) Pub. No.: US 2025/0123130 A1
(43) Pub. Date: Apr. 17, 2025

(54) Fluid Meter with Wake-Up Circuit

(71) Applicant: SAGEMCOM ENERGY & TELECOM SAS, Bois-Colombes (FR)

(72) Inventor: Henri Teboulle, Bois-Colombes (FR)

(21) Appl. No.: 18/910,468

(22) Filed: Oct. 9, 2024

(30) Foreign Application Priority Data
Oct. 12, 2023 (FR) 2310957

(51) Int. Cl. G01F 1/66

(52) U.S. Cl. CPC G01F 1/662

(57) ABSTRACT

A fluid meter configured to perform metrological measurements in a fluid circulation pipe, including: an electric generator configured to be driven by the circulation of the fluid, at least one metrological sensor configured to perform metrological measurements in the fluid pipe, a control block configured to receive the metrological measurements, a first wake-up circuit coupled to the electric generator at a first end and to the control block at a second end, and configured to generate an edge on a first electrical signal at the second end in response to the establishment of a voltage at the first end caused by the driving of the electric generator by the circulation of the fluid, the control block being configured to implement a wake-up of the fluid meter in response to the edge on the first electrical signal.

### FIELD OF THE INVENTION

The invention belongs to the technical field of fluid meters. A fluid meter is a metrology apparatus configured to perform metrological measurements in a fluid circulation pipe. The fluid can be liquid, such as for example water or oil, or gaseous, such as for example a gaseous mixture of hydrocarbon mainly composed of methane such as natural gas. The metrological measurements are generally a volume or a flow rate relating to the fluid circulating through the pipe.

### BACKGROUND OF THE INVENTION

In order to know some metrological data regarding the circulation of a fluid in a pipe, a fluid meter is commonly used to generate metrological measurements and to make these measurements available. In order to perform these metrological measurements, fluid meters equipped with means for communicating information relating to said metrological data have been developed. These communication means can be suitable for remote communication, and for example allow the wired or wireless transmission of this information. The communication means can also have several items of information in a display, organized into menus. In all cases, these metrological meters require an electrical power supply. However, the meters may be disposed in locations that do not allow easy connection to the electrical network, so that they must have an independent electrical power supply, not connected to the electrical network.

The simplest way of autonomously supplying electricity to a fluid meter is to equip it with an electric primary cell, i.e. an on-site non-rechargeable energy storage cell. The energy storage capacity must however be sufficient to allow the supply of electrical power for a long period of time (typically 20 years), which results in the use of very large primary cells. Furthermore, the service life of the primary cell depends on the electrical power consumption of the meter, which can significantly reduce the service life of the primary cell, which in any case eventually runs out and must be changed, a time-consuming operation requiring the monitoring of the state of the primary cell.

In order to overcome these drawbacks, it has been proposed to replace the electric primary cell with a rechargeable battery, for example powered by an electric generator configured to be driven by the circulation of the fluid in the pipe and to generate electricity which recharges the battery. However, the potentially intermittent aspect of the circulation of the fluid requires having a battery with a significant electrical storage capacity, which entails a large bulk and high costs.

### SUMMARY OF THE INVENTION

The invention therefore aims to propose a fluid meter equipped with a sleep and wake-up functionality which makes it possible to greatly reduce the electrical power consumption of the fluid meter without altering the responsiveness of the fluid meter.

For this purpose, the invention relates to a fluid meter configured to perform metrological measurements in a fluid circulation pipe and to communicate information relating to said metrological data, comprising:
an electric generator configured to be driven by the circulation of the fluid through the fluid pipe and to generate electricity,
at least one metrological sensor configured to perform metrological measurements in the fluid pipe,
a control block configured to receive the metrological measurements and to communicate information relating to said metrological data, and the fluid meter comprises a first wake-up circuit coupled to the electric generator at a first end and to the control block at a second end, the first circuit being configured to generate an edge on a first electrical signal at the second end, in response to the establishment of a voltage at the first end caused by the driving of the electric generator by the circulation of the fluid through the pipe, the control block being configured to implement a wake-up of the fluid meter in response to the edge on the first electrical signal at the second end.

Owing to the first wake-up circuit, the fluid meter can be in deep sleep, in a very energy-saving way since the first wake-up circuit does not include any active components consuming electrical energy, but can still wake up immediately at the right time, namely when it is appropriate to perform metrological measurements, i.e. when the circulation of fluid through the pipe resumes.

The fluid meter is advantageously completed by the following different features taken alone or in their different possible combinations:
the fluid meter is configured to perform metrological measurements in the fluid pipe following the wake-up, and to go back to sleep as a function of the circulation of fluid through the pipe;
the fluid meter is configured to go back to sleep when metrological measurements report a zero flow rate during a first given time period or when the electric generator is no longer driven by the circulation of the fluid through the fluid pipe;
the first circuit comprises a transistor configured to turn on in response to the establishment of the voltage at the first end;
the transistor has its gate or its base connected to the first end and to a first resistance, and is connected to a work voltage by a second resistance, the second end to which the first electrical signal is applied being connected between the transistor and the second resistance;
the fluid meter further comprises a second wake-up circuit comprising a control member coupled to the control block by a third end, the control member being configured so that its actuation causes an edge on a second electrical signal at the third end, the control member being configured to implement a wake-up of the fluid meter in response to the edge on the second electrical signal at the third end;
the control block is configured to implement a management of a human-machine interface comprising the communication of information relating to said metrological data following the wake-up of the fluid meter, the fluid meter being configured to go back to sleep when a human-machine interface sleep criterion is met;
the human-machine interface sleep criterion is an absence of actuation of the control member for a second given time period;
the communication of the information relating to the metrological data is done by display on a screen and/or by transmission of said metrological data;
the edge is a falling edge.

The invention also relates to a method of management of the sleep of a fluid meter configured to perform metrological measurements in a fluid circulation pipe and to communicate information relating to said metrological data according to the invention, the method comprising: during a sleep of the fluid meter, during which a metrological sensor configured to perform metrological measurements in the fluid pipe does not perform any metrological measurements, the monitoring by a control block of the occurrence of an edge on a first electrical signal at a second end of a first wake-up circuit coupled at a first end to an electric generator configured to be driven by the circulation of the fluid through the fluid pipe and to generate electricity,
following the detection by the control block of an edge on the first electrical signal at the second end, the implementation by the control block of a wake-up of the fluid meter in response to the edge on the first electrical signal at the second end, and
the control block causes the fluid meter to go to sleep as a function of the circulation of fluid through the pipe.

Preferably, the control block:
monitors, during a sleep of the fluid meter, the occurrence of an edge on a second electrical signal at a third end of a second wake-up circuit,
implements a wake-up of the fluid meter in response to an edge on the second electrical signal at the third end,
implements a management of the human-machine interface comprising the communication of information relating to said metrological data following the wake-up of the fluid meter,
causes the fluid meter to go to sleep when a human-machine interface sleep criterion is met.

The invention also relates to a computer-readable program product comprising instructions which, when the program is executed by a control block of a fluid meter according to the invention, cause said control block to implement the steps of the method according to the invention. The computer program product is typically a computer-readable non-transitory medium comprising instructions which, when the program is executed by a control block of a fluid meter according to the invention, cause said control block to implement the steps of the method according to the invention. Such a computer-readable medium can for example be a hard disk, an SSD disk, a flash memory, or an optical disc.

### BRIEF DESCRIPTION OF THE DRAWINGS

FIG. 3 shows the variation in a quantity of energy consumed to transmit a radio signal over time.

In all the figures, similar elements bear identical references. Other features, aims and advantages of the invention will become apparent from the following description, which is purely illustrative and non-limiting and which must be read in relation to the appended drawings in which:

FIG. 1 is a schematic overall view of a fluid meter according to a possible embodiment of the invention;

FIG. 2 is a diagram of a wake-up by the turbine of a fluid meter according to a possible embodiment of the invention;

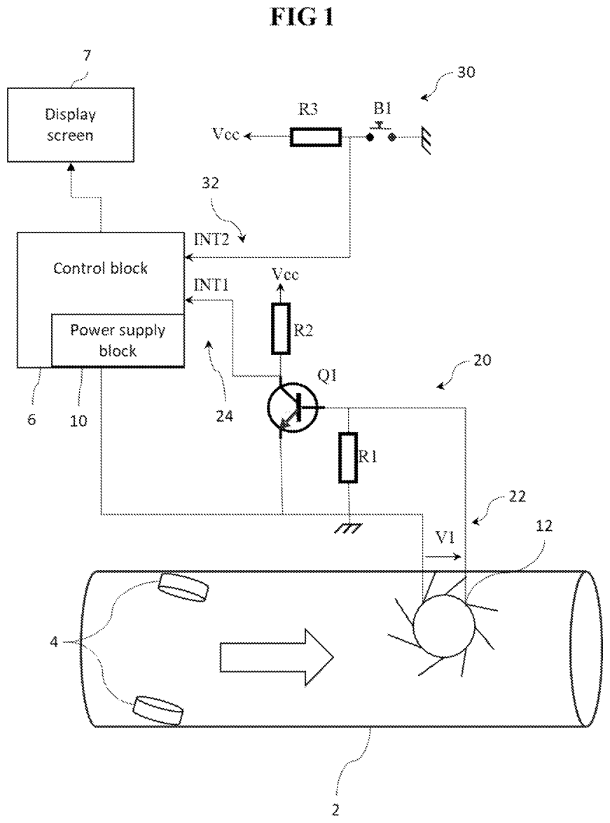

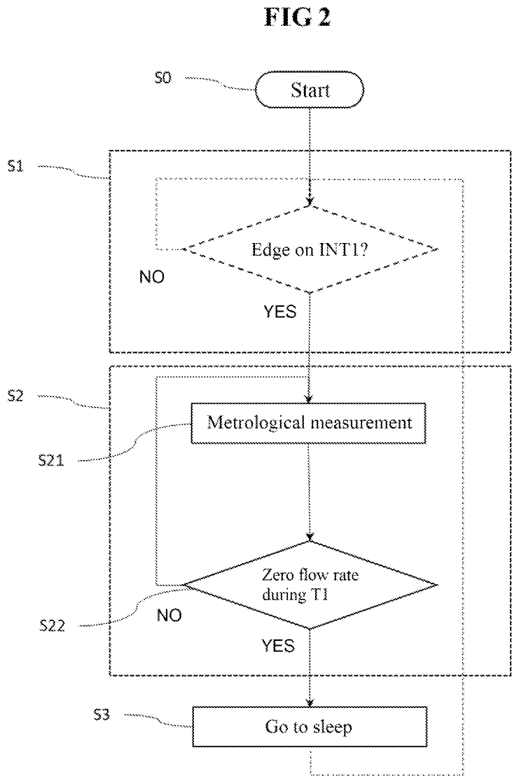

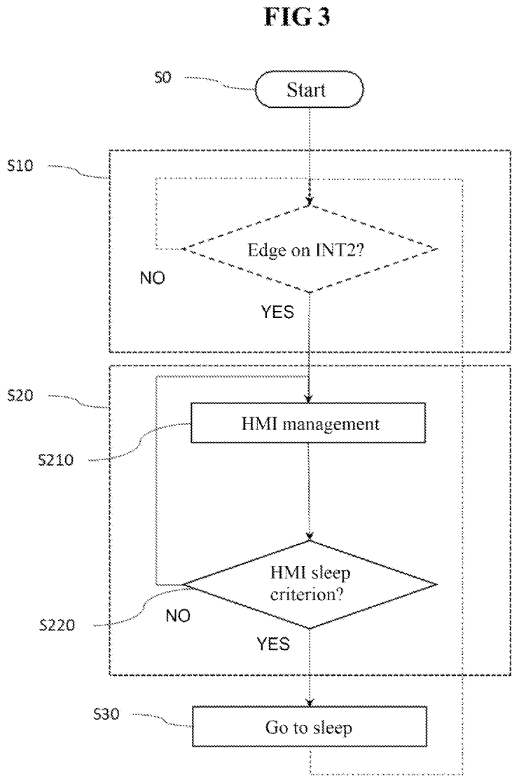

FIG. 3 is a diagram of a wake-up by a press on the control member of a fluid meter according to a possible embodiment of the invention.

### DETAILED DESCRIPTION OF THE INVENTION

FIG. 1 shows a fluid meter configured to perform metrological measurements in a fluid circulation pipe 2 and to communicate information relating to said metrological data. Typically, the fluid circulation pipe 2 is part of the fluid meter in the sense that the fluid meter comprises a duct portion in which the fluid circulates, which is integrated into the fluid circulation network. To perform metrological measurements, the fluid meter comprises at least one metrological sensor 4 configured to perform metrological measurements in the fluid pipe 2. The metrological sensor 4 is preferably disposed in the fluid pipe 2. The type of metrological sensor 4 depends on the technology used to perform the measurements, which may be an ultrasonic, an electromagnetic, a thermal or a Coriolis-effect technology. In the illustrated example, two ultrasonic transducers are disposed facing each other in the pipe to perform metrological measurements by ultrasound, in a known manner. The metrological measurements are generally a volume or a flow rate relating to the fluid circulating in the pipe 2, derived from the data collected by the metrological sensor or sensors 4.

The fluid meter comprises a control block 6 comprising at least a processor and a memory, and which is configured to receive the metrological measurements coming from the metrological sensor 4, and to communicate the items of information relating to said metrological data. Typically, the metrological sensor 4 can be connected to the control block 6, for example by a wired link, and transmits the metrological measurements to the control block 6.

The communication of the information relating to the metrological data is performed by display on a screen and/or by transmission. The fluid meter can thus have a display screen 7 on which the information relating to the metrological data can be displayed. The fluid meter can be equipped with a human-machine interface such as a button making it possible to cause the display of this information relating to the metrological data, and possibly to make this display change, for example by making it possible to scroll different types thereof on the display screen 7. The information relating to the metrological data can be transmitted outside of the fluid meter, preferably by a wireless link, in which case the fluid meter may comprise an antenna and any other known component making it possible to establish a remote communication with the fluid meter. The information relating to the metrological data may for example be an instantaneous flow rate, a cumulative flow rate (a volume), an average flow rate, etc.

Preferably, the fluid meter complies with the European Union Directive 2014/32/EU regarding the measuring instruments, better known as the MID (Measuring Instruments Directive). Particularly, the fluid meter must be able to be permanently communicate information relating to metrological data. Similarly, the fluid meter must be able at any time to perform metrological measurements. Consequently, the fluid meter must have an electrical power supply permanently.

For this purpose, the fluid meter comprises a power supply block 10 configured to permanently supply electricity to the control block 6. The power supply block 10 comprises at least one energy storage element, and in particular at least one battery or primary cell. The term “primary cell” should be understood to mean an electrical energy storage element which cannot be recharged, or whose configuration in the power supply block makes the charging within this power supply block impossible. The primary cell preferably has a maximum energy reserve of less than 100 Wh, such as for example 30.6 Wh (8.5 Ah on 3.6 V) or 68.4 Wh (19 Ah on 3.6 V).

The fluid meter also comprises an electric generator 12 configured to be driven by the circulation of fluid in the pipe and to generate electricity. Preferably, the electric generator 12 is coupled to the control block 6, for example to the power supply block 10. At least a part of the electric generator 12 is disposed in the pipe 2 in contact with the fluid in order to draw mechanical energy and convert it into electricity. Typically, this electric generator 12 is an impeller, preferably vaned, incorporating a rotor and a stator. The electric generator 12 supplies electricity available outside the pipe 2. Preferably, the electric generator 12 is disposed downstream, in the direction of circulation of the fluid, with respect to the metrological sensor 4 in the fluid pipe 2, in order to avoid disrupting these metrological measurements.

As an addition or alternative to the primary cell, the power supply block 10 may comprise an electrical energy storage element rechargeable by the electric generator 12. In this case, the electric generator 12 can be coupled to the power supply block 10 of the control block 6 to supply the rechargeable electrical energy storage element. The rechargeable electrical energy storage element may for example be a rechargeable battery or a capacitor, preferably having a maximum energy reserve Eₘₐₓ greater than or equal to 0.5 Wh, and even preferably greater than or equal to 0.8 Wh. The capacitor is preferably a supercapacitor. Typically, the capacitor may be a HLC for Hybrid Layer Capacitor, but may also be any type of supercapacitor making it possible to offer a maximum energy reserve Eₘₐₓ greater than or equal to 0.5 Wh. Preferably, the maximum energy Eₘₐₓ of the capacitor is at least 20 times lower than the maximum energy of a primary cell if one is present. For example, the rechargeable electrical energy storage element can deliver an electrical load of 0.222 Ah on 3.6 V.

In sleep, the fluid meter does not perform metrological measurements in the fluid pipe. For example, when the metrological sensor 4 comprises ultrasonic transducers, these do not emit any ultrasounds when the fluid meter is in sleep. Similarly, in sleep, there is no communication of information relating to the metrological data, for example by display on a screen and/or by transmission of said metrological data. All or most of the functions of the fluid meter can be disabled during sleep. The electrical power consumption is then zero or virtually zero which makes it possible to avoid consuming the electrical energy of the electrical storage element such as the primary cell or the capacitor. The electrical storage element can then be chosen to have a smaller storage capacity, reducing its volume and cost.

It is however advisable to be able to wake up the fluid meter as efficiently as possible. With reference to FIG. 1 and to FIG. 2, the fluid meter comprises a first electrical circuit 20 coupled to the electric generator 12 at a first end 22 and to the control block 6 at a second end 24. In the absence of circulation of fluid through the fluid pipe 2, the electric generator 12 does not rotate and there is no voltage across the terminals of the first end 22 coupled to the electric generator. When the electric generator 12 is driven by the circulation of the fluid through the fluid pipe 2, a non-zero voltage V1 appears across the terminals of the first end 22, which reflects the electricity generated by the electric generator 12. A first electrical signal INT1 is applied to the second end 24. The first electrical circuit 20 is configured to generate an edge on the first electrical signal INT1 at the second end 24 in response to the establishment of a voltage V1 at the first end caused by the driving of the electric generator by the circulation of the fluid through the fluid pipe 2.

The first electrical circuit 20 comprises a transistor Q1 configured to turn on in response to the establishment of the voltage V1 at the first end 22. Preferably, the transistor is an NPN transistor rather than a PNP transistor. More precisely, the transistor Q1 has its gate or its base connected to the first end 22 and to a first resistance R1 connected to the ground, and is connected to a work voltage Vcc by a second resistance R2, the second end 24 to which the first signal INT1 is applied being connected between the transistor Q1 and the second resistance R2. The work voltage Vcc is typically chosen to allow the various supplied components to operate, and can be between 3 V and 4 V, and is for example of 3.3 V. The resistances R1 and R2 can for example have resistance values between 0.5 and 10 kΩ.

In this example, the transistor Q1 is an NPN bipolar transistor, the base of which is coupled to the first end 22, while its emitter is connected to the ground (or to any other voltage different from the work voltage and allowing the transistor Q1 to turn on), and its collector is coupled both to the second resistance R2 and to the second end 24. Other configurations could be envisaged, such as for example the use of an insulated—gate field effect transistor (or MOSFET), with the gate replacing the base, the source the emitter, and the drain the collector.

As long as the transistor V1 is turned off, the first electrical signal at the second end keeps a constant voltage imposed by the work voltage Vcc. When a non-zero voltage V1 is established at the first end 22 following the driving of the electric generator 12, the transistor Q1 turns on, connecting the second end 24 to the ground via the transistor Q1. The second end 24 therefore undergoes an abrupt variation in voltage, and the first electrical signal has an edge. Preferably, the edge is a falling edge as in the illustrated example but could be a rising edge in another configuration.

The control block 6 is configured to implement a wake-up of the fluid meter in response to the edge on the first electrical signal INT1 at the second end 24. As illustrated in FIG. 2, starting from an initial state S0, the fluid meter is in sleep state, and the control block 6 monitors the first electrical signal INT1 to detect an edge in it (step S1). If there is no edge on the first electrical signal INT1, the fluid meter remains in the sleep state. If an edge on the first electrical signal INT1 is detected, the control block causes the wake-up of the fluid meter (step S2). The wake-up implies the re-enabling of functions of the sleep meter that were not enabled during sleep, and in particular the performing of the metrological measurements, but possibly other functions such as data recording. The fluid meter is therefore configured to perform metrological measurements (step S21) in the fluid pipe 2 following the wake-up. The fluid meter can also be configured to communicate the information relating to the metrological data following the wake-up.

The control block 6 commands the fluid meter to go back to sleep as a function of the circulation of fluid through the pipe 2, and more precisely the going to sleep is caused by the absence of circulation of fluid through the pipe 2. Preferably, the fluid meter goes back to sleep on the basis of the results of the metrological measurements. The fluid meter can be configured to go back to sleep when metrological measurements report a zero or insufficient flow rate (typically below a flow rate threshold) during a first given period of time T1 (step S22). This first given period of time T1 is preferably between 1s and 30s, and is for example of 5s.

The fluid meter can be configured to go back to sleep when the electric generator 12 is no longer driven by the circulation of the fluid through the fluid pipe 2, for example when a voltage across the terminals of the electric generator becomes virtually zero, less than a threshold. In fact, in the absence of circulation of fluid through the pipe 2, the voltage V1 at the first end 22 becomes zero again, and the transistor Q1 turns off again. The second end 24 thus finds itself isolated from the ground, and regains a voltage related to the work voltage Vcc. The first electrical signal INT1 then has an edge, typically rising as it is here, indicating the absence of fluid circulation. The detection of this edge on the first electrical signal INT1 by the control block 6 can be used to cause the meter to go to sleep.

When the absence of circulation of fluid in the pipe 2 has been established by the control block 6, the fluid meter goes to sleep (step S3), and the control block 6 once again starts to monitor the first electrical signal INT1 to detect an edge in it (step S1).

The first electrical circuit 20 makes it possible to limit the metrological measurements solely to the times at which they are relevant and useful, namely when fluid is circulating in the pipe 2. The first electrical circuit 20 allows wake-up as soon as the electric generator 12 starts to be driven by the circulation of the fluid, thus ensuring that any circulation of fluid will be measured. Moreover, the first electrical circuit 20 does not consume any electricity in sleep, unlike systems which for example rely on sensors.

To ensure wake-up by a user at any time, particularly to allow communication of the information relating to the metrological data, the fluid meter comprises a second wake-up circuit 30 comprising a control member B1 coupled to the control block S1 by a third end 32. The control member B1 is configured so that its actuation causes an edge on a second electrical signal INT2 at the third end 32. In particular, the control member B1 can keep the second circuit 30 open when it is not enabled, and closes the second circuit 30 when it is enabled. The control member B1 is preferably a pre-positioned switch, the contacts and maneuvering member of which return to an open position when the maneuvering member is released after a command. For example, the control member B1 can be a pushbutton. The control member B1 can be part of the human-machine interface described above.

In the illustrated example, the control member B1 is connected to a work voltage Vcc, by way of a third resistance R3, and the ground, or any other voltage different from the work voltage Vcc. The third end 32 is connected to the control member B1 and to the third resistance R3. The third resistance R3 can for example have a resistance value between 0.5 and 10 kΩ.

When a user enables the control member B1, for example by pressing on the pushbutton, the third end 32 becomes connected to the ground, and the third end 32 therefore undergoes an abrupt variation in voltage, and the second electrical signal INT2 has an edge. Preferably, the edge is a falling edge as in the illustrated example but could be a rising edge in another configuration.

The control block 6 is configured to implement a wake-up of the fluid meter in response to the edge on the second electrical signal at the third end 32. As illustrated on FIG. 3, starting from an initial state S0, the fluid meter is in sleep state, and the control block 6 monitors the second electrical signal INT2 to detect an edge in it (step S10). If there is no edge on the second electrical signal INT2, the fluid meter remains in the sleep state. If an edge of the second electrical signal INT2 is detected, the fluid meter wakes up (step S20).

The control block 6 is configured to implement a human-machine interface management (step S210) comprising the communication of information relating to said metrological data following the wake-up of the fluid meter. The communication of the information relating to the metrological data is for example done by display on the screen 7 and/or by transmission of the metrological data. Thus, the user, by actuating the control member B1, can access the information relating to the metrological data, and optionally other information, such as for example a meter number. The human-machine interface management can involve input-output peripherals such as for example one or more buttons, with which the user can interact to control the fluid meter. For example, the user can modify the display on the screen 7, typically to navigate between menus or change the displayed data. The user can also modify items of information relating to the metrological data, such as for example resetting a cumulative flow rate or volume.

The fluid meter is configured to go back to sleep when a human-machine interface sleep criterion is met (step S220). Preferably the sleep criterion is based on an interaction with a user. For example, the human-machine interface sleep criterion is an absence of actuation of the control member B1 during a second given period of time T2. This second given period of time T2 is preferably between 1s and 30s, and is for example 5s. If the human-machine interface sleep criterion is not met, for example because the control member B1 has been actuated within the second time period T2, the fluid meter continues the management of the human-machine interface (step S210). If on the other hand the human-machine interface sleep criterion is met, for example because the control member B1 has not been actuated for at least the second time period T2, the fluid meter goes back to sleep (step S30), and interrupts the management of the human-machine interface.

The fluid meter goes back to sleep as a function of the circulation of fluid through the pipe 2, or rather is caused by the absence of circulation of fluid in the pipe 2. Preferably, the fluid meter goes back to sleep on the basis of the results of the metrological measurements. The fluid meter can be configured to go back to sleep when metrological measurements report a zero or insufficient flow rate (typically below a flow rate threshold) for a first given period of time T (step S22). The fluid meter can be configured to go back to sleep when the electric generator 12 is no longer driven by the circulation of the fluid through the fluid pipe 2, for example when a voltage across the terminals of the electric generator becomes virtually zero, less than a threshold.

Thus, the fluid meter is able to immediately respond to any prompt from a user actuating the control member B1, but without consuming electricity in sleep mode to ensure wake-up.

The first wake-up circuit 20 and the second wake-up circuit 30 make it possible to make provision for a very deep and therefore very energy-saving sleep, being devoid of any active components requiring a power supply, while still allowing the fluid meter to thoroughly and responsively fulfil its functions of metrological measurement and human-machine interface management. The electrical storage element is therefore less used and can be chosen to have a lower energy storage capacity, with consequently a reduced bulk and a lower cost, while preserving or increasing its life.

The invention is not limited to the embodiment described and shown in the appended figures. Modifications remain possible, particularly from the point of view of the composition of the various technical features or by substitution of technical equivalents, without however departing from the field of protection of the invention.

1. A fluid meter configured to perform metrological measurements in a fluid circulation pipe and to communicate information relating to said metrological data, comprising:
an electric generator configured to be driven by the circulation of the fluid in the fluid pipe and to generate electricity,
at least one metrological sensor configured to perform metrological measurements in the fluid pipe,
a control block configured to receive the metrological measurements and to communicate information relating to said metrological data,
characterized in that the fluid meter comprises:
a first wake-up circuit coupled to the electric generator at a first end and to the control block at a second end, the first circuit being configured to generate an edge on a first electrical signal at the second end in response to the establishment of a voltage at the first end caused by the driving of the electric generator by the circulation of the fluid through the pipe, the control block being configured to implement a wake-up of the fluid meter in response to the edge on the first electrical signal at the second end, and
a second wake-up circuit comprising a control member coupled to the control block by a third end, the control member being configured so that its actuation causes an edge on a second electrical signal at the third end, the control block being configured to implement a wake-up of the fluid meter in response to the edge on the second electrical signal at the third end.

2. The fluid meter as claimed in claim 1, wherein the fluid meter is configured to perform metrological measurements in the fluid pipe following the wake-up, and to go back to sleep as a function of the circulation of fluid through the pipe.

3. The fluid meter as claimed in claim 2, wherein the fluid meter is configured to go back to sleep when metrological measurements report a zero flow rate during a first given time or when the electric generator is no longer driven by the circulation of the fluid through the fluid pipe.

4. The fluid meter as claimed in claim 1, wherein the first circuit comprises a transistor configured to turn on in response to the establishment of the voltage at the first end.

5. The fluid meter as claimed in claim 4, wherein the transistor has its gate or its base connected to the first end and to a first resistance, and is connected to a work voltage by a second resistance, the second end to which the first electrical signal is applied being connected between the transistor and the second resistance.

6. The fluid meter as claimed in claim 1, wherein the control block is configured to implement the management of a human-machine interface comprising the communication of information relating to said metrological data following the wake-up of the fluid meter, the fluid meter being configured to go back to sleep when a human-machine interface sleep criterion is met.

7. The fluid meter as claimed in claim 6, wherein the human-machine interface sleep criterion is an absence of actuation of the control member for a second given time period.

8. The fluid meter as claimed in claim 1, wherein the communication of the information relating to the metrological data is done by display on a screen and/or by transmission of said metrological data.

9. The fluid meter as claimed in claim 1, wherein the edge is a falling edge.

10. A method of management of the sleep of a fluid meter configured to perform metrological measurements in a fluid circulation pipe and to communicate information relating to said metrological data as claimed in any of the preceding claims, the method comprising:
during a sleep of the fluid meter, during which a metrological sensor configured to perform metrological measurements in the fluid pipe does not perform any metrological measurements, the monitoring by a control block of the occurrence of an edge on a first electrical signal at a second end of a first wake-up circuit coupled at a first end to an electric generator configured to be driven by the circulation of the fluid through the fluid pipe and to generate electricity,
following the detection by the control block of an edge on the first electrical signal at the second end, the implementation by the control block of a wake-up of the fluid meter in response to the edge on the first electrical signal at the second end, and
the control block causes the fluid meter to go to sleep as a function of the circulation of fluid through the pipe.

11. The method as claimed in claim 10, wherein the control block:
monitors, during a sleep of the fluid meter, the occurrence of an edge on a second electrical signal at a third end of a second wake-up circuit,
implements a wake-up of the fluid meter in response to an edge on the second electrical signal at the third end,
implements a management of the human-machine interface comprising the communication of information relating to said metrological data following the wake-up of the fluid meter,
causes the fluid meter to go to sleep when a human-machine interface sleep criterion is met.

12. A computer-readable computer program product comprising instructions which, when the program is executed by a control block of a fluid meter as claimed in claim 1.
